(19) United States
(12) Patent Application Publication
(10) Pub. No.: US 2026/0312699 A1
(43) Pub. Date: Oct. 8, 2026

(54) ELECTRONIC DEVICE PERFORMING RF CALIBRATION AND COMPUTING SYSTEM INCLUDING THE SAME

(71) Applicant: Samsung Electronics Co., Ltd., Suwon-si (KR)

(72) Inventors: Yeonjae CHO, Suwon-si (KR); Yongha PARK, Suwon-si (KR); Donghyun LEE, Suwon-si (KR); Cheolsun LIM, Suwon-si (KR); Donghyuk JANG, Suwon-si (KR); Heonhwi JEONG, Suwon-si (KR); Seyoung OH, Suwon-si (KR)

(73) Assignee: Samsung Electronics Co., Ltd., Suwon-si (KR)

(21) Appl. No.: 19/634,525

(22) Filed: Mar. 31, 2026

(30) Foreign Application Priority Data
Apr. 2, 2025 (KR) 10-2025-0042802

(51) Int. Cl. H04B 17/11; H04B 17/391

(52) U.S. Cl. CPC H04B 17/11; H04B 17/3913

(57) ABSTRACT

An operating method of an electronic device may include determining a plurality of first RF (radio frequency) signals among RF signals of a plurality of frequencies, obtaining a plurality of first measurement values of the plurality of first RF signals, predicting a plurality of second measurement values of the RF signals using a learning model, based on the plurality of first measurement values, and performing RF calibration using the predicted plurality of second measurement values.

### CROSS-REFERENCE TO RELATED APPLICATION

This application claims priority to and the benefit of Korean Patent Application No. 10-2025-0042802 filed with the Korean Patent Office on Apr. 2, 2025, the entire contents of which are incorporated herein by reference.

### BACKGROUND

The present inventive concepts relate to electronic devices for performing RF calibration and computing systems including the same.

RF (Radio frequency) circuits are electronic circuits used in electronic devices that perform wireless communications, and are responsible for transmitting, receiving, and processing RF signals. RF circuits are circuits used to transmit and receive data between electronic devices and base stations by changing data signals into signals of a frequency that may be transmitted externally.

### SUMMARY

Some example embodiments relate to electronic devices for performing RF calibration, and computing systems including the same. Such electronic devices and computing systems may support wireless communications in recent high-frequency bands, and may be equipped with RF circuit modules in a plurality of chip sets. In wireless communication technology in high-frequency bands, such electronic devices and computing systems may transmit RF signals with accurate power for high transmission rates, and may reduce or minimize the distortion that occurs in the signal while passing through the signal path. Such electronic devices and computing systems may reduce, minimize, or prevent signal distortion and communication performance degradation. As a result, such electronic devices and computing systems may be configured to perform RF calibration with reduced consumption of time such that the RF calibration is performed more quickly and/or with reduced power consumption without compromising RF calibration accuracy and/or precision and therefore without compromising RF transmission performance and thus without compromising wireless communication performance enabled by the electronic devices and/or computing systems.

Some example embodiments relate to an electronic device and a computing system including the same for performing RF calibration using a learning model so as to configure the electronic device and computing system including same to perform RF calibration with reduced consumption of time such that the RF calibration is performed more quickly and/or with reduced power consumption without compromising RF calibration accuracy and/or precision and therefore without compromising RF transmission performance and thus without compromising wireless communication performance enabled by the electronic device.

An operating method of an electronic device according to some example embodiments may include: determining a plurality of first RF (radio frequency) signals among RF signals of a plurality of frequencies, obtaining a plurality of first measurement values of the plurality of first RF signals, determining a predicted plurality of second measurement values of the RF signals using a learning model, based on the plurality of first measurement values, and performing RF calibration using the predicted plurality of second measurement values.

A computing system according to some example embodiments may include: a first electronic device configured to generate a plurality of first RF signals among RF signals of a plurality of frequency bands, measure a plurality of first set values of a down-conversion mixer that configure the down-conversion mixer to optimize characteristics of the plurality of first RF signals, and output the plurality of first set values, and a second electronic device configured to receive the plurality of first set values, and determine a predicted plurality of second set values that are determined to configure the down-conversion mixer to optimize one or more characteristics of the RF signals using a learning model.

A computing system according to some example embodiments may include: a first electronic device configured to output a plurality of first RF signals among RF signals of a plurality of frequencies to an external device through an antenna module, generate a plurality of first feedback signals of the plurality of first RF signals, and measure power values of the plurality of first feedback signals, and a second electronic device configured to receive the power values of the plurality of first feedback signals from the first electronic device, and determine predicted power values of a plurality of second feedback signals of the RF signals as predicted power values of the plurality of second feedback signals using a first learning model based on the power values of the plurality of first feedback signals.

### BRIEF DESCRIPTION OF THE DRAWINGS

FIG. 1 is a block diagram of an electronic device according to some example embodiments.

FIG. 2 is a diagram for explaining a first RF calibration operation according to some example embodiments.

FIG. 3 is a diagram for explaining a first RF calibration operation according to some example embodiments.

FIG. 4 is a diagram for explaining a first RF calibration operation according to some example embodiments.

FIG. 5 is a diagram for explaining a first RF calibration operation according to some example embodiments.

FIG. 6 is a diagram for explaining a second RF calibration operation according to some example embodiments.

FIG. 7 is a diagram showing data output by a feedback circuit according to some example embodiments.

FIG. 8 is a diagram showing output data of a first learning model corresponding to input data according to some example embodiments.

FIG. 9 is a block diagram of an electronic device according to some example embodiments.

FIG. 10 is a diagram illustrating data received by the calibration logic from an external device according to some example embodiments.

FIG. 11 is a diagram showing output data of a second learning model corresponding to input data according to some example embodiments.

FIG. 12 is a diagram for explaining an RF calibration operation according to some example embodiments.

FIG. 13 is a diagram for explaining the operation of an RF circuit according to some example embodiments.

FIG. 14 is a computing system according to some example embodiments.

FIG. 15 is a flowchart illustrating a method of operating a computing system according to some example embodiments.

FIG. 16 is a flowchart illustrating a method of operating a computing system according to some example embodiments.

### DETAILED DESCRIPTION

Below, with reference to the attached drawings, some example embodiments of the present inventive concepts are described in detail so that a person having ordinary skill in the art to which the present inventive concepts pertain may easily practice the present inventive concepts. However, the present inventive concepts may be implemented in various different forms and are not limited to the example embodiments described herein.

In order to clearly explain the present inventive concepts in the drawings, parts that are not related to the explanation are omitted, and similar parts are given similar drawing reference numerals throughout the specification. In the flowchart described with reference to the drawings, the order of operations may be changed, several operations may be merged, some operations may be split, and certain operations may not be performed.

Additionally, expressions written in the singular may be interpreted as singular or plural, unless explicit expressions such as “one” or “singular” are used. Terms that include ordinal numbers, such as first, second, etc., may be used to describe various components, but the components are not limited by these terms. These terms may be used to distinguish one component from another.

The terms “unit” and the like described in the specification may mean a unit capable of processing at least one function or operation described in the specification, and this may be implemented by hardware or a circuit, software, or a combination of hardware or a circuit and software. Additionally, at least some of the components or functions of the RF calibration operations according to the example embodiments described below may be implemented as a program or software, and the program or software may be stored in a computer-readable medium.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

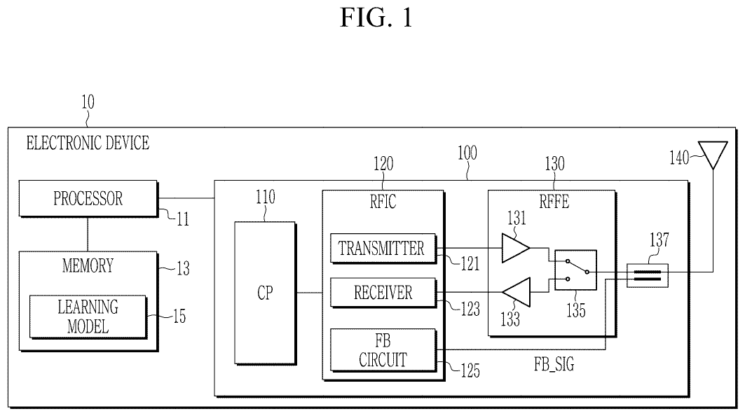

FIG. 1 is a block diagram of an electronic device 10 according to some example embodiments.

In some example embodiments, the electronic device 10 may include a processor 11, memory 13, and RF circuit 100.

The processor 11 may be implemented in various types of electronic devices, processing circuitry, or the like such as a CPU (Central Processing Unit), an AP (Application Processor), a GPU (Graphic Processing Unit), an NPU (Neural Processing Unit), an MCU (Micro Controller Unit), etc. The processor 11 may be any semiconductor device that executes instructions stored in memory 13. The processor 11 may execute a program (e.g., program of instructions) stored in memory 13. The program may be executed by one or more processors and cause the RF circuit 100 to perform various operations based on data output (transmitted) from a learning model 15 stored in memory 13. It will be understood that a learning model as described herein (e.g., learning model 15) may be implemented (e.g., operated) based on a processor (e.g., processor 11) executing a program of instructions stored in a memory (e.g., memory 13).

The memory 13 may store various data used by at least one component of the electronic device (e.g., processor 10, etc.). The memory 13 may include volatile memory such as SRAM and/or DRAM and nonvolatile memory such as flash memory, PRAM and/or RRAM. In some example embodiments, the memory 13 may store a learning model 15 (e.g., the memory 13 may store a program of instructions that, when executed by processor 11, causes the processor 11 to implement the learning model 15). A learning model 15 may be a type of artificial neural network that extracts high-level features from input data through the plurality of processing layers and performs tasks such as classification, recognition, and prediction based on these features. In some example embodiments, the learning model 15 may include a plurality of learning models.

In some example embodiments, the RF circuit 100 may include an RFFE (a Radio Frequency Front End) 130 electrically connected to an antenna module 140, an RFIC (an RF Integrated Circuit) 120 electrically connected to the RFFE 130, a CP (a Communication Processor) 110, and a coupler 137.

In some example embodiments, the antenna module 140 may transmit or receive signals or power to or from an external device (e.g., an external electronic device). The antenna module 140 may radiate RF signals or receive RF signals from the outside (e.g., the external device).

In some example embodiments, the RFFE 130 may include at least one PA (power amplifier) 131, at least one LNA (low noise amplifier) 133, and a switch 135 electrically connected to the PA 131 and the LNA 133. The PA 131 may amplify the RF signal output by the transmitter 121 of RFIC 120. The RF signal amplified by the PA 131 may pass through the switch 135 and coupler 137 and may be output through the antenna module 140. The LNA 133 may amplify an RF signal received by the antenna module 140 and passed through the switch 135. The RF signal amplified by the LNA 133 may be transmitted to the receiver 123 of the RFIC 120.

In some example embodiments, when an RF signal amplified by the PA 131 passes through the coupler 137, the coupler 137 may, in response, generate a replica signal of the RF signal provided from the RFFE 130 to the antenna module 140 as a feedback signal FB_SIG and transmit the feedback signal FB_SIG to the feedback circuit 125 of the RFIC 120, such that the feedback signal FB_SIG generated by the coupler 137 may be transmitted to the feedback circuit 125 of the RFIC 120. However, example embodiments of the configuration of the RFFE 130 are not limited thereto. For example, the RFFE 130 may further include a BPF Band Pass Filter that passes (e.g., selectively transmits, filters, etc.) only RF signals of a particular (e.g., desired) frequency band.

In some example embodiments, the RFIC 120 may include a transmitter 121, a receiver 123, and a feedback circuit 125. The RFIC 120 may be electrically connected to the CP 110. For example, the RFIC 120 may transmit data to the CP 110, receive data from CP 110, receive a control signal from the CP 110, or the like. For example, the RFIC 120 may receive a control signal from the CP 110 to control at least one of the transmitter 121, the receiver 123, or the feedback circuit 125.

The transmitter 121 may receive a digital signal from the CP 110 and generate an RF signal based on the digital signal for transmission to the RFFE 130 (e.g., the PA 131). For example, the transmitter 121 may include a digital-to-analog converter DAC (not shown) for converting a digital signal output by the CP 110 into an analog signal and an up-conversion mixer (not shown) for up-converting the frequency of the analog signal by mixing the converted analog signal and a signal output by an oscillator (not shown). The RFIC 120 may include one or more transmitters.

The receiver 123 may convert an RF signal received through the antenna module 140 and amplified by the RFFE 130 into a digital signal for transmission to the CP 110. For example, the receiver 123 may include a down-conversion mixer (not shown) for down-converting the frequency of an analog signal by mixing an analog signal received through an antenna module 140 and a signal output by an oscillator (not shown), and an analog-to-digital converter ADC (not shown) for converting the analog signal into a digital signal. RFIC 120 may include one or more receivers.

The feedback circuit 125 may receive a feedback signal FB_SIG provided from the coupler 137. The feedback circuit 125 may provide a feedback signal FB_SIG provided from the coupler 137 to other components within the RFIC 120. For example, the feedback signal FB_SIG received by the feedback circuit 125 may be amplified, down-converted, and ADC converted by other components within the RFIC 120.

In this way, the RF circuit 100 may perform various processing operations on RF signals transmitted to the outside or received from the outside through the antenna module 140. However, while the RF signal passes through various paths within the RF circuit 100, the RF signal may be distorted due to performance deviations of components within the RF circuit 100 or external factors. To reduce, minimize, or prevent such distortions, the RF circuit 100 may perform an RF calibration operation on the RF signal (also referred to herein as performing RF calibration on the RF signal) to reduce or minimize signal distortion and optimize signal characteristics associated with the RF signal. The RF calibration operation may be performed based on an operational configuration of the RF circuit 100, including one or more setting values, set values, operational parameters, or the like. The RF circuit 100 may perform an RF calibration on the RF signal to calibrate the RF signal into a calibrated RF signal. The RF circuit 100 may be configured to transmit such calibrated RF signals to one or more external devices and/or to provide calibrated RF signals based on RF signals received from one or more external devices (also referred to herein as implementing wireless communication of RF signals to/from one or more external devices using the RF-calibrated RF circuit 100) with reduced distortion and/or degradation of such RF signals based on the RF calibration and thus providing improved communication performance, so that the RF circuit 100 may exhibit improved wireless communication functionality based on performing the RF calibration operation, alone or in combination with implementing said wireless communication using the RF-calibrated RF circuit 100.

The RF circuit 100 may adjust setting values of one or more elements thereof that are used to calibrate RF signals to support transmitting and/or receiving of RF signals to/from one or more external devices. As described herein, the RF circuit 100 may support transmitting and/or receiving of RF signals to/from one or more external devices based on processing the RF signals, including performing RF calibration on the RF signals, using one or more components of the RF circuit 100 (e.g., a mixer of the RF circuit 100), where said one or more components may be configured to implement processing of RF signals, including adjusting one or more characteristics of the RF signals, according to one or more setting values. The RF circuit 100 may adjust setting values that may be used by one or more components of the RF circuit 100 (e.g., a mixer) to perform the RF calibration to affect the characteristics of each RF band signal during the processing (e.g., RF calibration) of the RF signal by the RF circuit 100 in order to optimize the characteristics of the RF signal (hereinafter referred to interchangeably as ‘RF band signal’) of the frequency band corresponding to each RF band (e.g., the center frequency of each RF band). Here, optimizing the characteristics of the RF signal may refer to minimizing the intermodulation distortion IMD that occurs in the RF signal in the RF circuit 100. For example, the RF circuit 100 may measure and adjust the setting value of a mixer within the RF circuit 100 to reduce or minimize intermodulation distortion IMD occurring in the RF signal in the RF circuit 100. Here, the mixer may refer to a down-conversion mixer, and the setting value of the mixer may refer to, but is not limited to, the resistance values of nonlinear elements (e.g., diodes, transistors, etc.) within the down-conversion mixer, where the RF circuit 100 may be configured to adjustably control characteristics of an RF signal being processed (e.g., RF calibrated) by the RF circuit 100 based on the resistance values of nonlinear elements of the down-conversion mixer. In some example embodiments, the RF circuit 100 may measure and adjust the overall frequency characteristics constituting each RF band to compensate for performance deviations of components within the RF circuit 100. For example, the RF circuit 100 may measure the power (dBm) of the feedback signal for each frequency constituting each RF band and increase or decrease the power of the RF signal radiated by the antenna module 140 to compensate for the difference between the RF signal radiated by the antenna module 140 and transmitted to an external device and the feedback signal FB_SIG. However, since the calibration operation (e.g., RF calibration) of the RF circuit 100 is performed for the entire frequency constituting each RF band or RF band, there is a problem that the RF calibration operation consumes a lot of time and thus may consume excessive computing resources and/or electrical power.

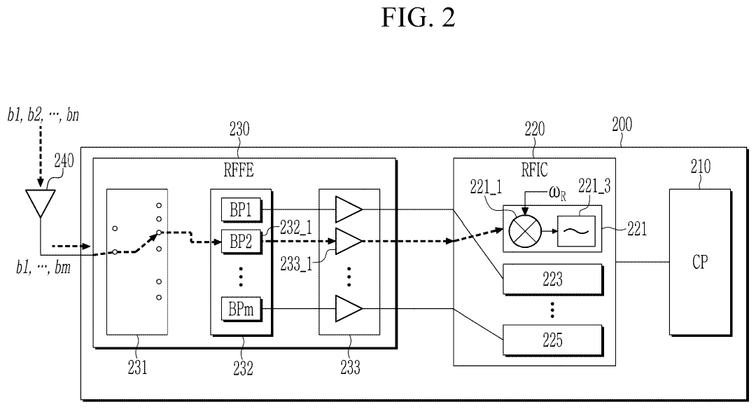

To solve this problem, an electronic device 10 according to some example embodiments may obtain first measurement values for (e.g., associated with) some of the RF signals (e.g., a first plurality of RF signals) among the RF signals of a plurality of frequencies (e.g., a limited portion of RF signals among the RF signals of the plurality of frequencies, where the limited portion of RF signals may exclude a separate, remainder portion of RF signals among the RF signals of the plurality of frequencies). For example, an RF circuit 100 within an electronic device 10 may input some RF signals (also referred to herein as a limited portion of RF signals among the RF signals of the plurality of frequencies) into a down-conversion mixer and measure a setting value that minimizes intermodulation distortion IMD occurring in the down-conversion mixer. An RF circuit 100 within an electronic device 10 may measure the setting value of a down-conversion mixer that reduces or minimizes intermodulation distortion IMD for some RF signals (e.g., the limited portion of RF signals). An RF circuit 100 within an electronic device 10 may obtain, as a first measurement value, a setting value of a down-conversion mixer that reduces or minimizes intermodulation distortion IMD for some RF signals (e.g., the limited portion of RF signals). In some example embodiments, the RF circuit 100 may generate a feedback signal for some RF signals output from the RF circuit 100 and measure the power (e.g., power level) of the feedback signal. An electronic device 10 according to some example embodiments may predict second measurement values of RF signals from first measurement values (e.g., may determine predicted second measurement values of the RF signals based on the first measurement values) using a learning model 15. Specifically, the electronic device 10 may learn the tendency of setting values that optimize the characteristics of each RF band signal (e.g., to minimize intermodulation distortion of each RF band signal in the RF circuit 100) using a learning model 15 and predict the setting values that improve or optimize the characteristics of each RF band signal. The electronic device 10 may learn the tendency of the setting values of the down-conversion mixer (e.g., the resistance values of nonlinear elements (e.g., diodes, transistors, etc.) within the down-conversion mixer) that optimizes the characteristics of each RF band signal (e.g., minimizes intermodulation distortion of each RF band signal in the down-conversion mixer), and predict the setting values of the down-conversion mixer that configure the down-conversion mixer to optimize the characteristics of each RF band signal (e.g., as the predicted plurality of second measurement values) using the learning model 15. In some example embodiments, the electronic device 10 may learn the tendency of the values of the overall frequency-specific feedback signals constituting each RF band, and predict the power value of the frequency-specific feedback signals constituting each RF band (e.g., as the predicted plurality of second measurement values) using the learning model 15. An RF circuit 100 according to some example embodiments may perform some of the RF calibration operations using values predicted from a learning model 15 (also referred to as predicted values determined from the learning model 15). A detailed description of the operation method of the electronic device 10 will be described later with reference to FIG. 2 to FIG. 16. In some example embodiments, the learning model 15 may be implemented through various models such as, but not limited to, CNN (a convolutional neural network), a MLP (multi-layer perceptron), deep neural network regression, or the like. It will be understood that, as described herein, predicting a value, for example predicting the setting values of the down-conversion mixer that improves or optimizes the characteristics of each RF band signal using the learning model 15, may be referred to as determining predicted values that are predicted to have certain characteristics, for example determining predicted setting values of the down-conversion mixer that are predicted to improve or optimize the characteristics of each RF band signal using the learning model 15.

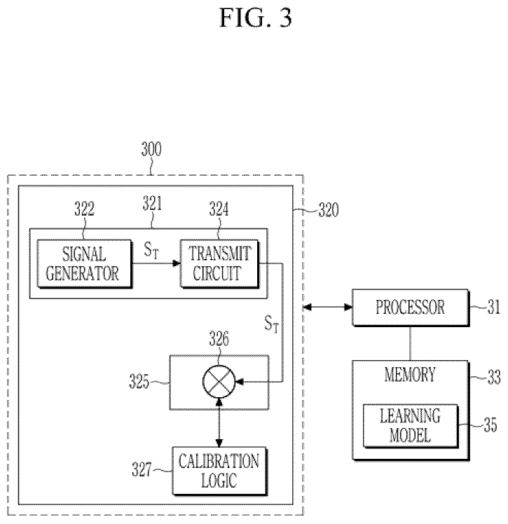

FIGS. 2, 3, 4, and 5 are drawings for explaining a first RF calibration operation according to some example embodiments. Specifically, to explain the setting values for improving or optimizing the characteristics of RF band signals, FIG. 2 illustrates the receiving path of RF signals within RFFE and RFIC. It will be understood that the RF circuit 200 and the components thereof as shown in FIG. 2 may be implemented by the RF circuit 100 and corresponding components thereof as shown in FIG. 1. It will be understood that the RF circuit 300 and the components thereof as shown in FIG. 3 may be implemented by the RF circuit 200 and corresponding components thereof as shown in FIG. 2, and thus may be implemented by the RF circuit 100 and corresponding components thereof as shown in FIG. 1. It will be understood that the RF calibration operation described with regard to FIGS. 2 to 5 may be implemented by RF circuit 200 and the components thereof as shown in FIG. 2 and thus may be implemented by the RF circuit 100 and corresponding components thereof as shown in FIG. 1.

Referring to FIG. 2, in some example embodiments, an RF signal may be received at the RF circuit 200 via the antenna module 240 (which may be implemented by antenna module 140) and transmitted to the CP 210 (which may be implemented by CP 110) via the RFFE 230 (which may be implemented by the RFFE 130) and the RFIC 220 (which may be implemented by the RFIC 120). The antenna module 240 may receive various RF band signals b1, b2, ..., bn having different frequency bands, where “n” may be any natural number. Since the bandwidth, characteristics, center frequency, etc. of each band are different, the path through which each RF band signal passes within the RF circuit 200 may be different.

In some example embodiments, the RF band signals b1, b2, ..., bn may form (e.g., define) the plurality of band groups. Depending on the band group, the band path through which the RF band signal passes may be different. For example, a band path through which first RF band signals corresponding to the first band group pass may be different from a band path through which second RF band signals corresponding to the second band group pass. FIG. 2 shows the band path of some RF band signals b1, ..., bm among the plurality of RF band signals b1, b2, ..., bn (also referred to herein interchangeably as a limited portion of the RF band signals) (where, “m” is a natural number less than or equal to “n”). In the following, some RF band signals b1, ..., bm are assumed to form (e.g., define) a first band group. The first band group may be referred to as being a limited portion of the plurality of band groups, such that a separate band group of the plurality of band groups is excluded from the first band group.

In some example embodiments, the RFFE 230 may include an antenna switch module 231 (which may be implemented by switch 135), a BPF 232, and an LNA 233 (which may be implemented by LNA 133). In some example embodiments, RF band signals b1, ..., bm within the first band group input to the RF circuit 200 through the antenna module 240 may pass through the BP2 232_1 of the BPF 232 through the antenna switch module 231 and be input to the LNA 233_1 of the LNA 233, the LNA 233_1 corresponding to the BP2 232_1. The amplified signal from LNA 233_1 may be input to RFIC 220. In this way, all RF band signals included in one band group may be input to the RFIC 220 through the same band path within the RFFE 230, and RF band signals included in each of the different band groups may be input to the RFIC 220 through different band paths within the RFFE 230.

In some example embodiments, the band path through which the RF band signal passes within the RFIC 220 may be different depending on the band group. Referring to FIG. 2, RFIC 220 may include the plurality of band paths 221, 223, and 225, and RF band signals may pass through different band paths within RFIC 220 depending on the band group. For example, RF band signals b1, ..., bm within the first band group may be input to the CP 210 through the first band path 221 of the RFIC 220, and RF band signals within other band groups may be input to the CP 210 through the second band path 223 or the third band path 225 of the RFIC 220.

In some example embodiments, each of the plurality of band paths 221, 223, 225 within the RFIC 220 may include various components of the RF circuit 100. For example, the first band path 221 within the RFIC 220 may include a down-conversion mixer 221_1 that performs frequency down-conversion on an RF band signal by mixing an RF band signal b1, ..., bm received from an RFFE 230 with a local oscillator signal ωR, and a filter 221_3 that filters a signal down-converted in frequency by the down-conversion mixer 221_1 to remove noise and other components from the signal. However, the scope of the present inventive concepts is not limited thereto, and the first band path 221 may include more components such as an amplifier. Additionally, the second band path 223 and the third band path 225 may also include the components described above.

Meanwhile, in the process of mixing and processing the local oscillator signal ω_{R} and RF band signals b1, ..., bm in the down-conversion mixer 221_1 as part of the RF circuit 100 and/or 200 processing the RF band signals to support wireless communication (e.g., transmission and/or reception) of such RF band signals between an electronic device 10 and an external device, unwanted intermodulation distortion IMD of such RF band signals may occur. For example, when two or more frequency signals are simultaneously input to the down-conversion mixer 221_1, intermodulation distortion IMD may occur due to nonlinear elements (e.g., diodes, transistors, etc.) within the down-conversion mixer 221_1. Such intermodulation distortion IMD may significantly interfere with the signal being analyzed as a reception component by the RFIC 220 and causes a decrease in sensitivity. Accordingly, the RF circuit 200 may perform an RF calibration operation with regard to the RF band signals that reduces or minimizes intermodulation distortion IMD and thus improves sensitivity and thus RF signal processing performance (e.g., accuracy and/or precision) of the RF circuit 200 (and thus the RF circuit 100 and/or electronic device 10 including same) and thereby improves wireless communication functionality of the RF circuit 200, 100 and any electronic device 10 including same.

FIG. 3 is a diagram for explaining an RF calibration operation for an RF band signal according to some example embodiments. The RF circuit 300 and the components thereof as shown in FIG. 3 may be implemented by the RF circuit 200 and corresponding components thereof as shown in FIG. 2.

In some example embodiments, the RF circuit 300 may perform an RF calibration operation to improve or optimize the characteristics of each RF band signal (e.g., to configure the RF circuit 300 to process RF band signals with reduced or minimized distortion of characteristics thereof and thus to process RF band signals with improved accuracy and/or precision). RF calibration operations to improve or optimize the characteristics of each RF band signal may be performed using different learning models for each band group. Specifically, in order to improve or optimize the characteristics of each RF band signal, an RF calibration operation that adjusts setting values affecting the characteristics of the RF band signal (e.g., the resistance values of nonlinear elements of a down-conversion mixer 326 of the RF circuit 300) may be performed using different learning models for each band group. For convenience of explanation, the RF calibration operation for RF band signals b1, ..., bm within the first band group passing through the first band path 221 (of the RF circuit 200 of FIG. 2, which may implement the RF circuit 300 of FIG. 3 and which may be implemented by the RF circuit 100) is described here. However, the operations described below may be performed identically or similarly for RF band signals within other band groups passing through other band paths (e.g., 223, 225 in FIG. 2).

In some example embodiments, the RFIC 320 (which may be implemented by the RFIC 220 and/or RFIC 120) of the RF circuit 300 may include a transmitter 321 (which may be implemented by transmitter 121) and a receiver 325 (which may be implemented by receiver 123). The transmitter 321 may include a signal generator 322 and a transmit circuit 324. In some example embodiments, the signal generator 322 may generate a signal S_{T} of a particular (or, alternatively, predetermined) frequency. For example, the signal generator 322 may generate a signal S_{T} as an RF signal of a frequency band corresponding to each RF band (e.g., a center frequency of each RF band). In some example embodiments, the transmit circuit 324 may perform various processing operations on the signal S_{T} generated by the signal generator 322. For example, the transmit circuit 324 may include a filter, a mixer, an amplifier, and the like, and the transmit circuit 324 may perform various processing operations on the signal S_{T} using the filter, the mixer, the amplifier, and the like. Although the signal generator 322 is illustrated and described here as being included within the transmitter 321, example embodiments are not limited thereto.

In some example embodiments, the receiver 325 may receive a signal S_{T} from the transmitter 321. The receiver 325 may receive a signal S_{T} from the transmitter 321 through a feedback path. During the process of processing a signal S_{T} in a down-conversion mixer 326 within a receiver 325, intermodulation distortion IMD of the signal S_{T} may occur due to nonlinear elements within the down-conversion mixer 326 (e.g., due to resistance values of said nonlinear elements). RFIC 320 may perform RF calibration (e.g., involving adjusting resistance values of such nonlinear elements) to reduce or minimize intermodulation distortion IMD of signals processed by the RF circuit 300 and thus to improve the wireless communication performance of the RF circuit 300 and devices including same.

In some example embodiments, the RFIC 320 may include calibration logic 327. The calibration logic 327 may search for optimized set values (e.g., optimized resistance values of nonlinear elements within the down-conversion mixer 326) to minimize intermodulation distortion IMD (e.g., IMD of RF signals processed using the down-conversion mixer 326). The calibration logic 327 may detect intermodulation distortion IMD and search for optimized setting values to minimize the intermodulation distortion IMD. The calibration logic 327 may search for an optimized setting value to minimize intermodulation distortion IMD by adjusting the resistance values of nonlinear elements within the down-conversion mixer 326. The calibration logic 327 may determine the resistance values of the nonlinear elements in the down-conversion mixer 326 to minimize the intermodulation distortion IMD as optimized set values.

In some example embodiments, the calibration logic 327 may perform an RF calibration operation on some (e.g., a limited portion) of the RF band signals b1, ..., bm. The RF band signals b1, ..., bm may have a particular (or, alternatively, predetermined) frequency interval, and each RF band signal b1, ..., bm may be a frequency signal that increases at a particular (or, alternatively, predetermined) interval. For example, in each RF band signal b1, ..., bm, numbers such as ‘1’, ‘2’, ‘3’, etc., assigned in increasing order may represent frequency signals that increase at particular (or, alternatively, predetermined) intervals. In some example embodiments, the calibration logic 327 may determine some of the RF band signals b1, ..., bm within the first band group and search for optimized set values that minimize intermodulation distortion generated for some of the RF band signals. For example, the calibration logic 327 may determine RF band signals spaced apart by a particular (or, alternatively, predetermined) interval (e.g., ‘b1’, ‘b4’, ‘b7’ spaced apart by an interval of ‘3’) from the RF band signals b1, ..., bm as RF band signals (which may be referred to as a plurality of first RF signals) for performing the RF calibration operation. However, example embodiments of the method for determining the RF band signal for performing RF calibration operation are not limited thereto.

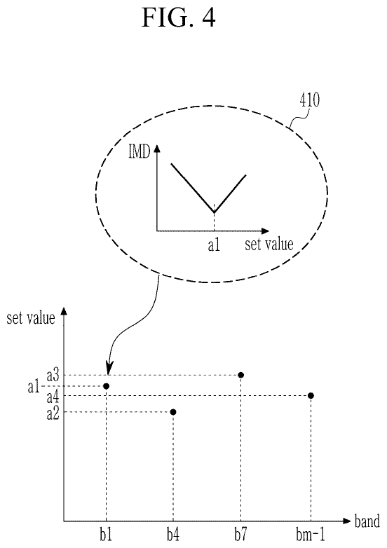

FIG. 4 is a diagram for explaining an RF calibration operation for some RF band signals according to some example embodiments.

Referring to FIG. 3 and FIG. 4, the calibration logic 327 may determine an optimized set value a1 that minimizes an intermodulation distortion IMD for the first RF band signal b1 (410). For example, the calibration logic 327 may measure an optimized set value a1 that minimizes intermodulation distortion IMD by controlling the resistance values of various elements within the down-conversion mixer (e.g., down-conversion mixer 326). The calibration logic 327 may determine the resistance values of various elements in the down-conversion mixer as optimized set values a1 to minimize intermodulation distortion IMD. The optimized set value a1 here may be expressed as a digital code value, but is not limited thereto. The calibration logic 327 may measure an optimized set value a2 that minimizes the intermodulation distortion IMD for the second RF band signal b4. The calibration logic 327 may measure an optimized set value a3 that minimizes the intermodulation distortion IMD for the third RF band signal b7. The calibration logic 327 may measure an optimized set value a4 that minimizes the intermodulation distortion IMD for the fourth RF band signal bm-1. In this way, the calibration logic 327 may perform an RF calibration operation to determine an optimized set value for some RF band signals b1, b4, b7, bm-1 among the RF band signals b1, ..., bm (also referred to herein as a limited portion of the RF band signals b1, ..., bm, excluding at least a remainder portion of the RF band signals b1, ..., bm), where the “some” RF band signals b1, b4, b7, bm-1 may be a plurality of first RF signals among RF signals of a plurality of frequencies. For example, the calibration logic 327 may input the “some” RF band signals b1, b4, b7, bm-1 (e.g., plurality of first RF signals) among the RF band signals b1, ..., bm into the down-conversion mixer and adjusting set values for controlling intermodulation distortion generated in the down-conversion mixer to determine set values a1, ..., a4 that minimize the intermodulation distortion in the “some” RF band signals b1, b4, b7, bm-1, where said determined set values may be the plurality of first measurement values that may be input to the learning model 35 to determine the predicted plurality of second measurement values (e.g., set values of the down-conversion mixer) for controlling intermodulation distortion generated in the down-conversion mixer for the RF band signals b1, ..., bm. The set values may be resistance values of elements in the down-conversion mixer, where the RF circuit 300 may be configured to adjust the resistance values of elements in the down-conversion mixer according to the set values to reduce or minimize intermodulation distortion in RF band signals processed using at least the down-conversion mixer of the RF circuit 300.

Referring also to FIG. 3, in some example embodiments, the calibration logic 327 may transmit optimized set values a1, a2, a3, a4 (e.g., set values that minimize the intermodulation distortion in the down-conversion mixer) corresponding to some RF band signals b1, b4, b7, bm-1 (which may be a limited portion of all RF band signals b1, ..., bm within the first band group and may be a plurality of first RF signals among RF signals of a plurality of frequencies) to the learning model 35. The learning model 35 may be implemented by the learning model 15 shown in FIG. 1. The learning model 35 may predict optimized set values (e.g., determine predicted optimized set values, which may be a predicted plurality of second measurement values of the RF signals) corresponding to all RF band signals b1, ..., bm within the first band group (e.g., including optimized set values for the remainder portion of the RF band signals that are excluded from the limited portion of RF band signals within the first band group) based on optimized set values a1, a2, a3, a4 corresponding to some RF band signals b1, b4, b7, bm-1 within the first band group (e.g., a plurality of first measurement values).

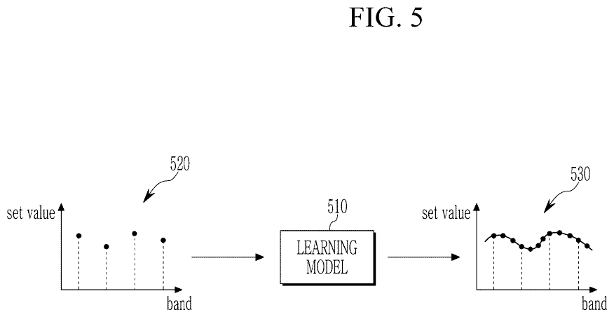

FIG. 5 illustrates an output data of a learning model corresponding to input data according to some example embodiments. The learning model 510 shown in FIG. 5 may be implemented by the learning model 35 shown in FIG. 3, which may be implemented by the learning model 15 shown in FIG. 1.

A learning model 510 according to some example embodiments may receive optimized set values corresponding to some RF band signals (e.g., a plurality of first measurement values of the plurality of first RF signals) as input data 520. At this time, some RF band signals may be included in the same band group (e.g., the first band group).

In some example embodiments, the learning model 510 may predict set values (e.g., determine a predicted plurality of second measurement values of the RF signals) that optimize the characteristics of all RF band signals within the first band group, including a remainder portion of RF band signals within the first band group that are excluded from the “some RF band signals” or “limited portion of RF band signals” that thus do not correspond to the received optimized set values that are input to the learning model 510, based on the input data 520, and output the predicted set values as output data 530. The learning model 510 may predict set values corresponding to all RF band signals within the first band group based on optimized set values corresponding to some RF band signals within the first band group (e.g., the limited portion of RF band signals), and output the predicted set values as output data 530.

Referring to FIG. 3, the learning model 35 may predict set values corresponding to all RF band signals belonging to the same band group as some RF band signals (e.g., the limited portion of RF band signals), based on optimized set values corresponding to the limited portion of RF band signals received from the calibration logic 327. In some example embodiments, the processor 31 may control the learning model 35 to predict and output set values corresponding to all RF band signals (e.g., a predicted plurality of second measurement values) belonging to the same band group as the limited portion of RF band signals (e.g., the plurality of first RF signals), based on optimized set values corresponding to some RF band signals (e.g., the plurality of first measurement values) received from the calibration logic 327. The calibration logic 327 may obtain set values corresponding to all RF band signals belonging to the same band group as some RF band signals (e.g., the limited portion of RF band signals) from the learning model 35 and adjust the set values of the down-conversion mixer so that the intermodulation distortion IMD is minimized. The calibration logic 327 may adjust the resistance values of the elements in the down-conversion mixer according to the predicted set values received from the learning model 35. This has the advantage of reducing the time consumed by RF calibration operations.

Here, the calibration logic 327 is illustrated and described as being located within the RFIC 320, but example embodiments of the calibration logic 327 are not limited thereto. For example, the calibration logic 327 may be located outside the RFIC 320. For example, the calibration logic 327 may be implemented by the processor 31 as shown in FIG. 3, which may be implemented by the processor 11 as shown in FIG. 1.

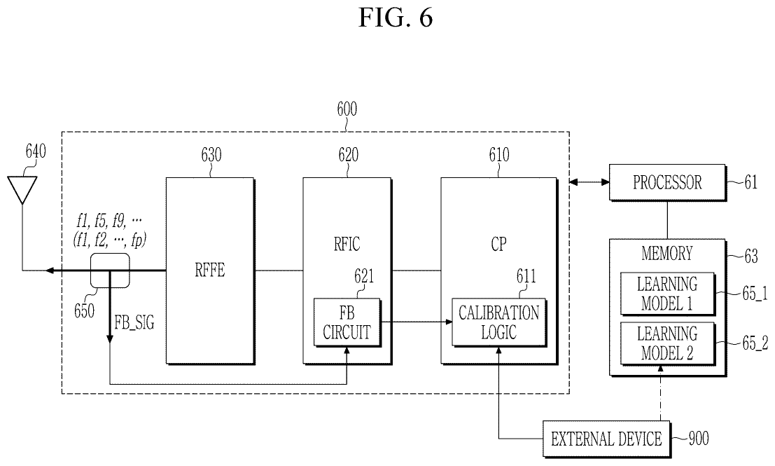

FIGS. 6, 7, 8, 9, 10, 11, and 12 are diagrams for explaining a second RF calibration operation according to some example embodiments. Specifically, FIG. 6 to FIG. 12 relate to an RF calibration operation for correcting performance deviations of components within an RF circuit, and FIG. 6 illustrates an electronic device according to some example embodiments. It will be understood that the RF circuit 600 and the components thereof as shown in FIG. 6 may be implemented by the RF circuit 100 and corresponding components thereof as shown in FIG. 1. It will be understood that the RF calibration operation described with regard to FIGS. 6 to 12 may be implemented by RF circuit 600 and the components thereof as shown in FIG. 6 and thus may be implemented by the RF circuit 100 and corresponding components thereof as shown in FIG. 1. It will be understood that, in some example embodiments, the example embodiments shown in FIGS. 6-12, including the RF circuit 600 and the functionality thereof, may be implemented by the RF circuit 200 shown and described with reference to FIGS. 2-5, in addition to the RF circuit 200 being configured to implement the functionality thereof shown and described with reference to FIGS. 2-5.

In some example embodiments, a digital signal output from CP 610 (which may be implemented by CP 110) may be converted into an analog signal in RFIC 620 (which may be implemented by RFIC 120) and transmitted to RFFE 630 (which may be implemented by RFFE 130) through RFIC 620. The signal transmitted to RFFE 630 is transmitted to the antenna module 640 (which may be implemented by antenna module 140) through the coupler 650 (which may be implemented by coupler 137) and may be radiated toward the outside (e.g., one or more external devices external to electronic device 10) through the antenna module 640. The coupler 650 may generate a feedback signal FB_SIG from an RF signal provided to the antenna module 640 from the RFFE 630. The coupler 650 may output (transmit) a replica signal of the RF signal provided from the RFFE 630 to the antenna module 640 as a feedback signal FB_SIG to the feedback circuit 621.

Due to various causes, such as performance deviations of components within the RF circuit 600, the power (e.g., power level, power magnitude, etc.) of the RF signal output from the RF circuit 600 and the power of the RF signal radiated by the antenna module 640 and transmitted to an external device may be different. Therefore, the difference between the power of the feedback signal FB_SIG and the power of the RF signal transmitted to the external device may be measured, and an RF calibration operation may be performed to reduce the difference between the power of the RF signal output from the RF circuit 600 and the power of the RF signal transmitted to the external device.

In some example embodiments, the RF circuit 600 may output some frequency signals among a plurality of frequency signals f1, f2, ..., fp constituting one frequency band (also referred to herein interchangeably as a limited portion of the plurality of frequency signals), where “p” may be any natural number. A plurality of frequency signals f1, f2, ..., fp may have a particular (or, alternatively, predetermined) frequency interval, and each of the frequency signals f1, f2, ..., fp may be frequency signals that increase at a particular (or, alternatively, predetermined) interval. For example, in each frequency signal f1, f2, ..., fp, numbers such as ‘1’, ‘2’, ‘3’, etc., assigned in increasing order may represent frequency signals that increase at particular (or, alternatively, predetermined) intervals. The RF circuit 600 may output some of the frequency signals among the plurality of frequency signals f1, f2, ..., fp under the control of the calibration logic 611. The calibration logic 611 may determine some of the frequency signals among the plurality of frequency signals f1, f2, ..., fp constituting one band as output signals. For example, the calibration logic 611 may determine frequency signals spaced apart by a particular (or, alternatively, predetermined) interval (e.g., ‘f1’, ‘f5’, ‘f9’ spaced apart by an interval of ‘4’) from among a plurality of frequency signals f1, f2, ..., fp constituting one band as output signals. However, example embodiments of a method for determining the frequency signal of the output signal are not limited thereto. In addition, although it has been described that the RF circuit 600 outputs some of the frequency signals among the plurality of frequency signals as output signals under the control of the calibration logic 611, example embodiments are not limited thereto.

In some example embodiments, the feedback circuit 621 may receive a feedback signal FB_SIG for some frequency signals f1, f5, f9 among a plurality of frequency signals f1, f2, ..., fp constituting one band (e.g., where the “some” frequency signals may be referred to as a plurality of first RF signals among RF signals of a plurality of frequencies and/or a limited portion of the plurality of frequency signals f1, f2, ..., fp), where “p” is any natural number. In some example embodiments, the feedback circuit 621 (which may be implemented by the feedback circuit 125) may detect the power value of the feedback signal FB_SIG and transmit the detected power value (e.g., as a plurality of first measurement values of the plurality of first RF signals) to the calibration logic 611. For example, the feedback circuit 621 may convert the feedback signal FB_SIG into power (e.g., a power value) and transmit it (the power, the power value, etc.) to the calibration logic 611 as a power value of the feedback signal FB_SIG (e.g., as a plurality of first measurement values of the plurality of first RF signals).

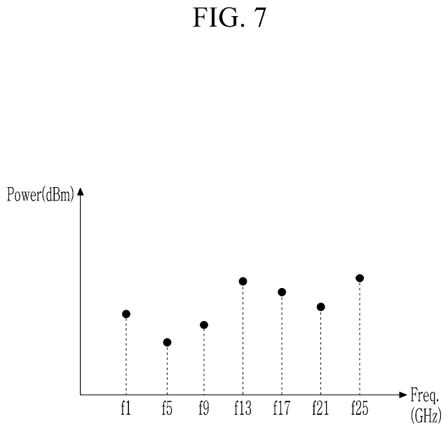

FIG. 7 is a diagram showing data output by a feedback circuit according to some example embodiments.

Referring to FIG. 7, a feedback circuit 621 may receive a feedback signal FB_SIG for some frequency signals f1, f5, f9 among a plurality of frequency signals f1, f2, ..., fp constituting one band, and detect a power value (dBm) of the feedback signal FB_SIG (e.g., as a plurality of first measurement values of a plurality of first RF signals). In some example embodiments, the feedback circuit 621 may transmit the detected power value (dBm) to the calibration logic 611. However, example embodiments are not limited thereto. For example, the feedback signal FB_SIG may be transmitted to a power detector existing inside or outside the RF circuit 600, and the calibration logic 611 may also receive the power value of the feedback signal FB_SIG from the power detector existing inside or outside the RF circuit 600.

Referring to FIG. 6, the calibration logic 611 may transmit the power value of the feedback signal FB_SIG to the first learning model 65_1 (which may be implemented by the learning model 15) in the memory 63 (which may be implemented by memory 13). The calibration logic 611 may receive the power value of the feedback signal FB_SIG for some frequency signals f1, f5, f9 among the plurality of frequency signals f1, f2, ..., fp constituting one band from the feedback circuit 621 and transmit the power value of the feedback signal FB_SIG to the first learning model 65_1. The first learning model 65_1 may predict the power value of the feedback signals for the plurality of frequency signals f1, f2, ..., fp that constitute the same band as the feedback signal FB_SIG (e.g., as a plurality of second measurement values of the RF signals) based on the power value of the feedback signal FB_SIG. However, the first learning model 65_1 may also receive the power values of the feedback signals FB_SIG for some frequency signals f1, f5, f9, directly from the feedback circuit 621.

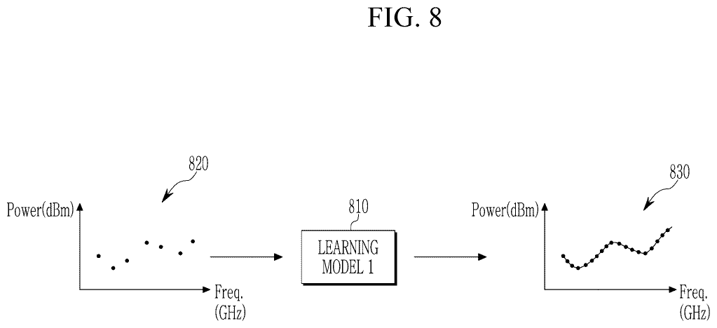

FIG. 8 shows output data of a first learning model corresponding to input data according to some example embodiments. The first learning model 810 shown in FIG. 8 may be implemented by the first learning model 65_1 shown in FIG. 6, which may be implemented by the learning model 15 shown in FIG. 1.

A first learning model 810 according to some example embodiments may receive power values (dBm) of feedback signals FB_SIG for some frequency signals f1, f5, f9 as input data 820. At this time, some frequency signals f1, f5, f9 may be included in the same band.

In some example embodiments, the first learning model 810 may predict the power values (e.g., determine predicted power values) of feedback signals for all frequency signals f1, f2, ..., fp included in the same band as some frequency signals f1, f5, f9 based on input data 820, and output the predicted power values as output data 830 (e.g., as the predicted plurality of second measurement values). The first learning model 810 may predict the power values of the feedback signals for all frequency signals f1, f2, ..., fp included in the same band as some frequency signals f1, f5, f9 based on the power values (dBm) of the feedback signals FB_SIG for some frequency signals f1, f5, f9, and output the predicted power values of the feedback signals for all frequency signals f1, f2, ..., fp as output data 830.

Referring to FIG. 6, the first learning model 65_1 may receive the power value of the feedback signal FB_SIG from the calibration logic 611. Specifically, the calibration logic 611 may receive the power value of the feedback signal FB_SIG for some frequency signals f1, f5, f9 (e.g., a limited portion of frequency signals) among the plurality of frequency signals f1, f2, ..., fp constituting one band from the feedback circuit 621 and transmit the power value of the feedback signal FB_SIG to the first learning model 65_1. In some example embodiments, the processor 61 may control the first learning model 65_1 to output predicted power values of feedback signals for a plurality of frequency signals f1, f2, ..., fp constituting the same band as the limited portion of frequency signals f1, f5, f9, based on power values of feedback signals FB_SIG for some frequency signals f1, f5, f9 received from the calibration logic 611. The calibration logic 611 may obtain predicted power values of feedback signals for a plurality of frequency signals f1, f2, ..., fp that constitute the same band as some frequency signals f1, f5, f9 from the first learning model 65_1.

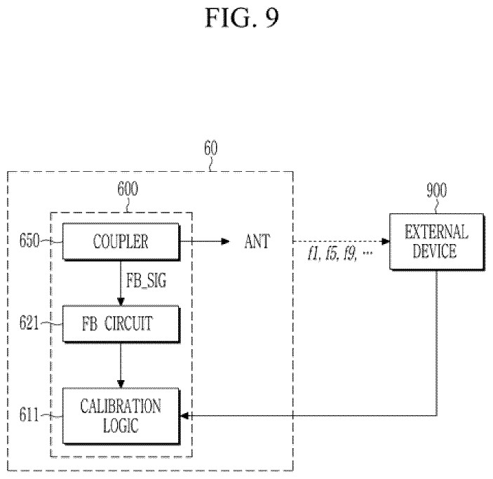

In some example embodiments, the calibration logic 611 may further receive a power value of an RF signal output from the antenna module 640 from an external device 900. Here, the external device 900 may be a measuring device (measuring equipment) for measuring the power value of an RF signal output from the antenna module 640. A detailed explanation of this is provided with reference to FIG. 9.

FIG. 9 is a block diagram of an electronic device according to some example embodiments. Specifically, FIG. 9 is a diagram for explaining the power value of an RF signal received by the calibration logic from an external device. The electronic device 60 and the components thereof as shown in FIG. 9 may be implemented by the electronic device 10 and corresponding components thereof as shown in FIG. 1.

Referring to FIG. 6 and FIG. 9, an RF signal generated within an RF circuit 600 may be transmitted to an antenna module ANT through a coupler 650 and radiated toward an external device 900 through the antenna module ANT. Additionally, the coupler 650 may generate a feedback signal FB_SIG from an RF signal transmitted to the antenna module ANT (which may be implemented by antenna module 640, which itself may be implemented by antenna module 140). The coupler 650 may transmit a replica signal of an RF signal provided to the antenna module ANT to the feedback circuit 621 as a feedback signal FB_SIG. The feedback circuit 621 may detect the power value of the feedback signal FB_SIG and transmit the detected power value to the calibration logic 611. However, example embodiments are not limited thereto.

In some example embodiments, the calibration logic 611 may further receive a power value of the RF signal from an external device 900. Specifically, the external device 900 may receive some frequency signals f1, f5, f9 from the electronic device 60 and measure power values of some frequency signals f1, f5, f9. Frequency signals may be RF signals. An external device 900 may transmit power values of some frequency signals f1, f5, f9 to the calibration logic 611.

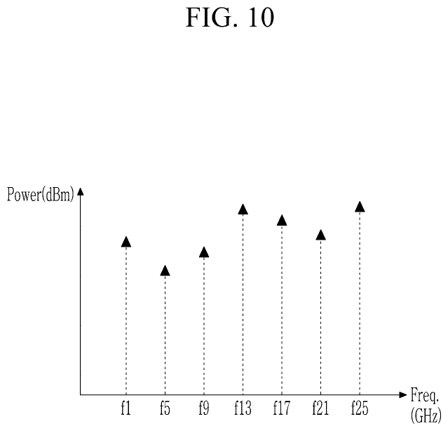

FIG. 10 is a diagram illustrating data received by the calibration logic from an external device according to some example embodiments.

Referring to FIG. 10, an external device 900 may receive some frequency signals f1, f5, f9 among a plurality of frequency signals f1, f2, ..., fp constituting one band, and measure the power value (dBm) of some of the frequency signals f1, f5, f9. In some example embodiments, the calibration logic 611 may receive, from the external device 900, power values (dBm) of some frequency signals f1, f5, f9 measured by the external device 900.

Referring to FIG. 6, the calibration logic 611 may transmit the power values of some frequency signals f1, f5, f9 received from an external device 900 to the second learning model 65_2 (which may be implemented by learning model 15, such that learning model 15 may include a plurality of learning models, including the first and second learning models 65_1 and 65_2). The calibration logic 611 may receive power values for some frequency signals f1, f5, f9 among a plurality of frequency signals f1, f2, ..., fp constituting one band from an external device 900 and transmit the power values for some frequency signals f1, f5, f9 to the second learning model 65_2. The second learning model 65_2 may predict the power values of the plurality of frequency signals f1, f2, ..., fp (e.g., determine predicted power values of the plurality of frequency signals) that constitute the same band as some frequency signals f1, f5, f9 based on the power values of some frequency signals f1, f5, f9. However, the second learning model 65_2 may also receive power values of some frequency signals f1, f5, f9 directly from an external device 900.

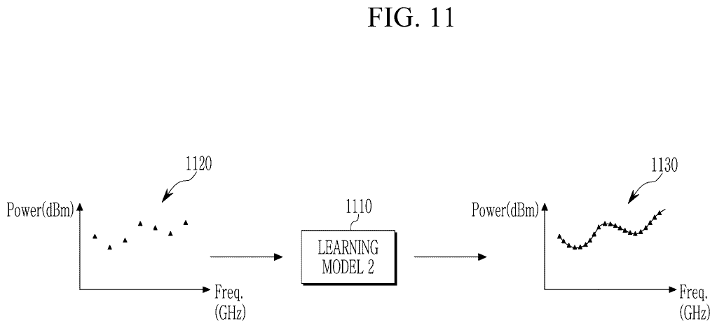

FIG. 11 shows output data of a second learning model corresponding to input data according to some example embodiments. The second learning model 1110 shown in FIG. 11 may be implemented by the second learning model 65_2 shown in FIG. 6, which may be implemented by the learning model 15 shown in FIG. 1.

A second learning model 1110 according to some example embodiments may receive power values (dBm) of some frequency signals f1, f5, f9 as input data 1120. At this time, some frequency signals f1, f5, f9 may be included in the same band.

In some example embodiments, the second learning model 1110 may predict power values of all frequency signals f1, f2, ..., fp included in the same band as some frequency signals f1, f5, f9 based on input data 1120, and output the predicted power values of all frequency signals f1, f2, ..., fp as output data 1130. The second learning model 1110 may predict the power values of all frequency signals f1, f2, ..., fp included in the same band as some frequency signals f1, f5, f9 based on the power values (dBm) of some frequency signals f1, f5, f9, and output the predicted power values of all frequency signals f1, f2, ..., fp as output data 1130. Here, the second learning model 1110 that predicts the power values of all frequency signals f1, f2, ..., fp included in the same band as some frequency signals f1, f5, f9 based on the power values (dBm) of some frequency signals f1, f5, f9 measured from the external device 900 may be different from the first learning model 810 that predicts the power values of feedback signals for all frequency signals f1, f2, ..., fp included in the same band as some frequency signals f1, f5, f9 based on the power values (dBm) of the feedback signals FB_SIG for some frequency signals f1, f5, f9 in FIG. 8, but example embodiments are not limited thereto.

Referring to FIG. 6, the second learning model 65_2 may receive power values of some frequency signals f1, f5, f9 (e.g., a limited portion of frequency signals) from the calibration logic 611. Specifically, the calibration logic 611 may receive power values of some frequency signals f1, f5, f9 among a plurality of frequency signals f1, f2, ..., fp constituting one band from an external device 900 and transmit the power values of some frequency signals f1, f5, f9 to the second learning model 65_2. In some example embodiments, the processor 61 may control the second learning model 65_2 to output predicted power values of a plurality of frequency signals f1, f2, ..., fp belonging to the same band as the limited portion of frequency signals f1, f5, f9, based on the power values of some frequency signals f1, f5, f9 received from the calibration logic 611. The calibration logic 611 may obtain predicted power values of the plurality of frequency signals f1, f2, ..., fp belonging to the same band as some frequency signals f1, f5, f9 from the second learning model 65_2.

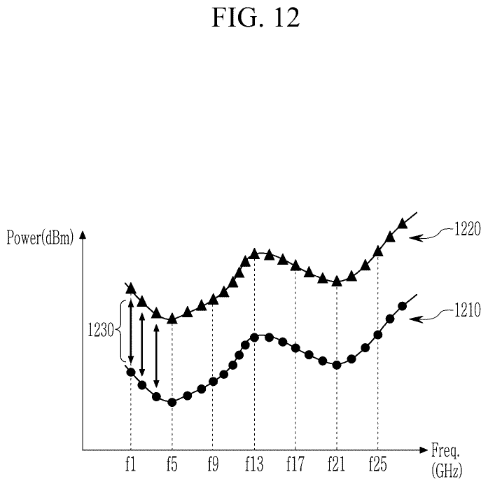

FIG. 12 is a diagram for explaining an RF calibration operation according to some example embodiments.

In some example embodiments, the calibration logic 611 may perform an RF calibration operation based on predicted power values 1210 of feedback signals for a plurality of frequency signals f1, f2, ..., fp received from a first learning model 65_1 (e.g., predicted second measurement values, for example provided by output data 830) and predicted power values 1220 of a plurality of frequency signals f1, f2, ..., fp received from a second learning model 65_2 (e.g., provided by output data 1130). Specifically, the calibration logic 611 may obtain (calculate) a difference value 1230 between the predicted power value 1210 of the feedback signal for the plurality of frequency signals f1, f2, ..., fp (e.g., the predicted second measurement values) and the predicted power value 1220 of the plurality of frequency signals f1, f2, ..., fp (e.g., predicted power values of the RF signals) in order to correct the difference between the predicted power value 1210 of the feedback signal for the plurality of frequency signals f1, f2, ..., fp and the predicted power value 1220 of the plurality of frequency signals f1, f2, ..., fp. The calibration logic 611 may adjust, for example increase or decrease, the power of the RF signal radiated by (e.g., through) the antenna module based on the difference value 1230.

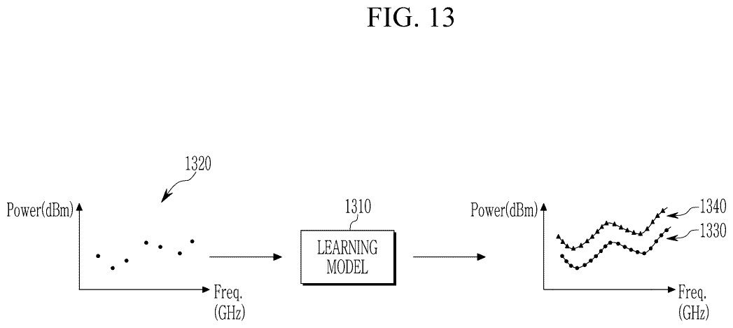

FIG. 13 is a diagram for explaining the operation of an RF circuit according to some example embodiments. The learning model 1310 shown in FIG. 13 may be implemented by the learning model 15 shown in FIG. 1. It will be understood that, in some example embodiments, the example embodiments shown in FIG. 13, may be implemented by the RF circuit 200 shown and described with reference to FIGS. 2-5, the RF circuit 600 shown and described with reference to FIGS. 6-12, the RF circuit shown and described with reference to FIG. 1, or any combination thereof, in addition to the functionality thereof shown and described with reference to FIGS. 1, 2-5, 6-12, or any combination thereof.

Referring to FIG. 6 and FIG. 13, the calibration logic 611 may receive a feedback signal FB_SIG for some frequency signals f1, f5, f9 from the feedback circuit 621 and output a power value of the feedback signal FB_SIG. A learning model 1310 according to some example embodiments may receive power values (dBm) of feedback signals FB_SIG for some frequency signals f1, f5, f9 from the calibration logic 611 as input data 1320. The learning model 1310 may predict the power values of the feedback signals for all frequency signals f1, f2, ..., fp included in the same band as some frequency signals f1, f5, f9 based on the power values (dBm) of the feedback signals FB_SIG for some frequency signals f1, f5, f9, and output the predicted power values of the feedback signals for all frequency signals f1, f2, ..., fp as output data 1330.

In some example embodiments, the learning model 1310 may further predict the power values of all frequency signals f1, f2, ..., fp included in the same band as some frequency signals f1, f5, f9 based on the power values (dBm) of the feedback signal FB_SIG for some frequency signals f1, f5, f9. The learning model 1310 may output predicted power values of all frequency signals f1, f2, ..., fp as output data 1340 based on the power values (dBm) of the feedback signals FB_SIG for some frequency signals f1, f5, f9. Specifically, the learning model 1310 may predict the power values of all frequency signals f1, f2, ..., fp transmitted from the RF circuit 600 to the external device 900 through the antenna module 640 based on the power values (dBm) of the feedback signals FB_SIG for some frequency signals f1, f5, f9. A learning model 1310 according to some example embodiments learns the tendency of power values of RF signals according to power values of feedback signals, and may predict power values of all frequency signals f1, f2, ..., fp transmitted from an RF circuit 600 to an external device 900 through an antenna module 640 based on power values (dBm) of feedback signals FB_SIG for some frequency signals f1, f5, f9. This has the advantage of shortening the time required to perform RF calibration and reducing the cost (e.g., reducing use of computing resources by the RF circuit) required to perform RF calibration, and further reducing power consumption by the RF circuit (e.g., RF circuit 600, RF circuit 100, RF circuit 200, RF circuit 300, or any combination thereof) to perform the RF calibration based on the reduced used of computing resources to perform the RF calibration, including based on performing the operations described with reference to any of FIGS. 1, 2-5, 6-12, 13, or any combination thereof..

Referring to FIGS. 1, 2-5, 6-12, and 13, based on performing RF calibration operations on RF band signals, which may include one or more of the RF calibration operations illustrated and described with reference to FIGS. 1, 2-5, 6-12, 13, or any combination thereof, an RF circuit (e.g., RF circuit 200, RF circuit 300, RF circuit 600, RF circuit 100, or any combination thereof), an electronic device including same (e.g., electronic device 10), any combination thereof, or the like may perform the RF calibration operations on RF band signals, which may include one or more of the RF calibration operations illustrated and described with reference to FIGS. 1, 2-5, 6-12, 13, or any combination thereof, to reduce, minimize or prevent distortion and/or degradation of said RF band signals due to intermodulation distortion IMD without compromising RF calibration accuracy and/or precision while also reducing time consumption, computing resource consumption, and/or electrical power consumption by such RF calibration operations and thus may improve processing speed, computing resource efficiency, and/or power consumption efficiency of the RF circuit, based on performing the RF calibration operations using a learning model (e.g., using the predicted plurality of second measurement values that are determined using the learning model based on the plurality of first measurement values). The RF circuit, the electronic device including same, any combination thereof, or the like may perform wireless communication operations (also referred to herein as implementing wireless communication operations) that may include transmitting calibrated RF band signals, that are calibrated based on performing such RF calibration operations on the RF band signals, to one or more external devices, providing (e.g., via an audio module) RF band signals that are received from one or more external devices and further calibrated based on performing such RF calibration operations on such received RF band signals, or any combination thereof. The RF circuit, the electronic circuit including same, any combination thereof, or the like may thus perform wireless communication operations that reduce, minimize or prevent distortion and/or degradation of wireless communication using said RF band signals while also reducing time consumption, computing resource consumption, and/or electrical power consumption associated with such wireless communication operations and thus may perform wireless communication operations with improved processing speed, computing resource efficiency, and/or power consumption efficiency. As a result, the functionality of the RF circuit, an electronic device including same, any combination thereof, or the like may be improved based on exhibiting faster processing of RF band signals (including RF calibration) to support wireless communication operations with reduced distortion and/or degradation of said RF band signals and with reduced consumption of time, computing resources, and/or electrical power by the RF circuit and/or electronic device.

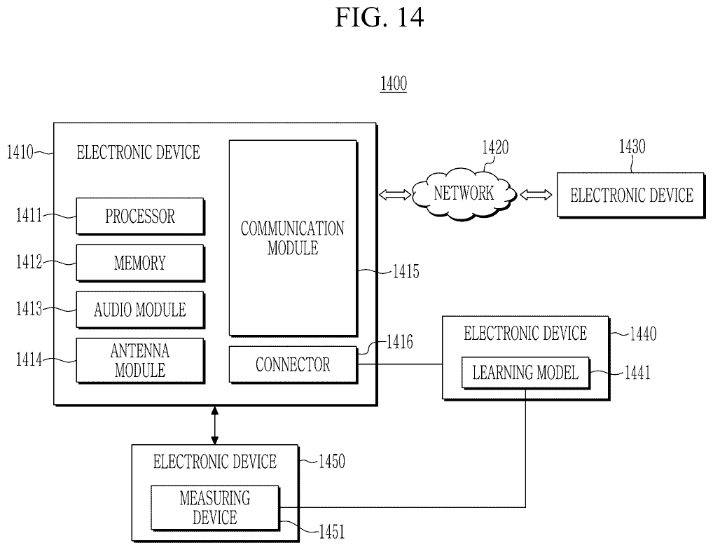

FIG. 14 is a computing system according to some example embodiments.

In some example embodiments, the computing system 1400 may include a plurality of electronic devices 1410, 1430, 1440, 1450. Electronic devices 1410, 1430, 1440, 1450 according to some example embodiments may be devices of various forms. Electronic devices 1410, 1430, 1440, 1450 may be fixed or mobile and may refer to any device capable of communicating with other electronic devices to transmit and receive data and/or control information. Electronic devices 1410, 1430, 1440, 1450 may include, for example, terminal equipment, a mobile station, a mobile terminal, a user terminal, a subscriber station, a wireless device, a handheld device, a computer device, a wearable device, or a home appliance device. The electronic device according to some example embodiments of this document is not limited to the devices described above.

In some example embodiments, the electronic device 1410 may communicate with the electronic device 1430 via a network 1420. According to some example embodiments, the network 1420 may be a short-range wireless communication network or a long-range wireless communication network. In some example embodiments, the electronic device 1410 may include a processor 1411, a memory 1412, an audio module 1413, an antenna module 1414, a communication module 1415, and a connector 1416. In some example embodiments, the electronic device 1410 may omit at least one of the above components (e.g., the audio module 1413), or may have one or more other components added. The electronic device 1410 may be referred to herein as a first electronic device, although example embodiments are not limited thereto.

The processor 1411 may execute a software program to control at least one other component within the electronic device 1410 including the processor 1411 and perform various data processing or calculations. In some example embodiments, the processor 1411 may execute various programs stored in the memory 1412.

The audio module 1413 may convert sound into an electrical signal, or vice versa. According to some example embodiments, the audio module 1413 may acquire sound through an input device (not shown) or output (emit) sound through an external electronic device (e.g., electronic device 1430) (e.g., speaker or headphone) directly or wirelessly connected to the electronic device 1410.

The antenna module 1414 may transmit signals or power to or receive signals or power from external electronic devices. A signal received by the antenna module 1414 may be processed in the communication module 1415, and a signal generated in the communication module 1415 may be transmitted to the outside through the antenna module 1414.

In some example embodiments, the communication module 1415 may establish a wireless communication channel between the electronic device and an external electronic device. A communication module 1415 according to some example embodiments may include an RF circuit described with reference to FIG. 1 to FIG. 13 (e.g., RF circuit 100, RF circuit 200, RF circuit 300, RF circuit 600, or any combination thereof) and may perform the operations described with reference to any of FIGS. 1, 2-5, 6-12, 13, or any combination thereof, including any of the RF calibration and/or power adjustment operations described with reference to any of FIGS. 1, 2-5, 6-12, 13, or any combination thereof. The wireless communication system that the electronic device 1410 may access through the communication module 1415 may be referred to as a RAT (Radio Access Technology), and may be a wireless communication system that utilizes a cellular network such as a next-generation wireless system, a 5 5th generation wireless system, an LTE (long term evolution) wireless system, an LTE-Advanced system, a CDMA (code division the plurality of access) wireless system, a GSM (global system for mobile communications) system, or a WLAN (Wireless Local Area Network) system or any other wireless communication system.

In some example embodiments, the communication module 1415 may perform various processing operations on a transmit signal transmitted to another electronic device through the antenna module 1414 or a receive signal received from another electronic device through the antenna module 1414. In addition, the communication module 1415 may perform an RF calibration operation on the transmission or reception signal to prevent the transmission or reception signal from being distorted due to performance deviations of components within the communication module 1415 or external factors while the transmission or reception signal passes through various paths within the communication module 1415, or to reduce or minimize such distortions of the transmission or reception signal.

In some example embodiments, the electronic device 1440 may include a learning model 1441. The electronic device 1440 may be connected to the electronic device 1410 via a connector 1416 within the electronic device 1410. Connectors 1416 may include, but are not limited to, an HDMI connector, a USB connector, etc.

In some example embodiments, the communication module 1415 may perform RF calibration on some of the transmit signals or receive signals. Specifically, the communication module 1415 may obtain measurement values for some of the transmitted signals or received signals. For example, the communication module 1415 may measure the power value of a feedback signal for some of the plurality of transmission signals (e.g., generate a plurality of first feedback signals of a plurality of first RF signals among RF signals of a plurality of signals outputted (transmitted) by the electronic device 1410 to electronic device 1430 and/or electronic device 1450 through the antenna module 1414, and measure power values of the plurality of first feedback signals, where the measured power values may be referred to as the measurement values), or measure an optimized setting value for some of the plurality of reception signals. Here, the optimized setting value may refer to the resistance value of the elements within the down-conversion mixer that reduces or minimizes intermodulation distortion components caused by some received signals. Additionally, here, the plurality of transmit signals may be included in the same frequency band, and the plurality of receive signals may pass through the same RF path within the communication module 1415.

In some example embodiments, the measurement values measured by the communication module 1415 may be transmitted to the learning model 1441 within the electronic device 1440 via the connector 1416. For example, in example embodiments where the measurement values include power values of a plurality of first feedback signals determined at electronic device 1410, the electronic device 1440 may receive such power values from the electronic device 1410. The electronic device 1440 may be referred to herein as a second electronic device, although example embodiments are not limited thereto. The learning model 1441 may predict measurement values for the plurality of transmission signals and the plurality of received signals (also referred to herein interchangeably as determining predicted measurement values for the plurality of transmission signals and the plurality of reception signals) based on measurement values measured by the communication module 1415. The learning model 1441 may include one or a plurality of learning models. For example, the learning model 1441 may include a first learning model that may predict power values of feedback signals for a plurality of transmit signals based on power values of feedback signals for some transmit signals (e.g., determine predicted power values of a plurality of second feedback signals of the RF signals using a first learning model based on the power values of the plurality of first feedback signals), and/or may include a second learning model that may determine predicted power values of the RF signals based on the power values of the plurality of first feedback signals, and/or may include a third learning model that may predict optimized settings that reduce or minimize intermodulation distortion IMD components for a plurality of received signals based on optimized settings that reduce or minimize intermodulation distortion IMD components for some received signals.

In some example embodiments, the learning model 1441 may further receive measurement values of the transmitted signal from a measuring device 1451 within the electronic device 1450 (to which the electronic device 1410 may output the RF signals of the plurality of frequencies through the antenna module 1414). Specifically, some of the transmission signals output by the communication module 1415 may be transmitted to the electronic device 1450, and the measuring device 1451 within the electronic device 1450 may measure the power value of some of the transmission signals. The measuring device 1451 may transmit the measured power value to the electronic device 1410 and/or the electronic device 1440. The measuring device 1451 may transmit the measured power value to the learning model 1441 within the electronic device 1440. In some example embodiments, the learning model 1441 may predict power values of the plurality of transmission signals (also referred to herein as determine predicted power values of the plurality of transmission signals, which may also be referred to as RF signals) based on power values of some transmission signals.

In some example embodiments, the communication module 1415 may receive predicted values of baseband signals for a plurality of received signals, predicted power values of feedback signals for a plurality of transmitted signals, and/or predicted power values of a plurality of transmitted signals from the learning model 1441. The communication module 1415 may perform an RF calibration operation to improve or optimize the characteristics of the RF signal based on the predicted value. For example, the communication module 1415 may receive predicted power values of a plurality of second feedback signals determined using learning model 1441 (e.g., a first learning model included therein) and predicted power values of the RF signals determined using learning model 1441 (e.g., a second learning model included therein), and adjust power values of the RF signals output from the antenna module based on a difference between the predicted power values of the plurality of second feedback signals and the predicted power values of the RF signals. The communication module 1415 may further cause transmission of RF signals on which the RF calibration operation is performed (referred to herein as calibrated RF signals) with reduced consumption of computing resources, reduced consumption of time (e.g., increased processing speed), with reduced consumption of electrical power by the electronic device 1410, any combination thereof, or the like, based on implementing any of the operations supporting RF calibration operations as described with reference to FIGS. 1 to 13.

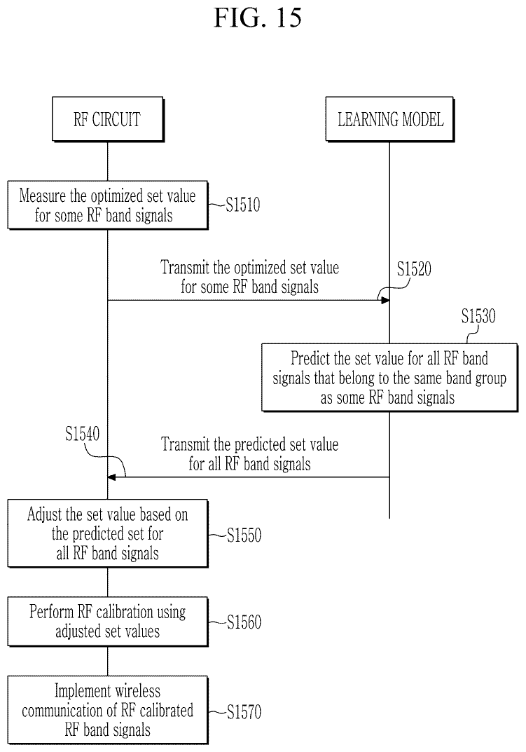

FIG. 15 is a flowchart illustrating a method of operating a computing system according to some example embodiments. The method shown in FIG. 15 may be implemented using an RF circuit which may be any of the RF circuits, modules including same, and/or electronic devices including same shown in any of FIGS. 1 to 14. The method shown in FIG. 15 may be implemented using a learning model which may be any of the learning models included in any of the circuits, devices, modules, or the like shown in any of FIGS. 1 to 14.

In some example embodiments, the RF circuit and the learning model may be included in the same electronic device. However, the RF circuit and the learning model may be included in different electronic devices.

In some example embodiments, the RF circuit may measure optimized set values for some RF band signals (e.g., a plurality of first RF band signals among RF band signals of a plurality of frequencies, which may be referred to herein as a limited portion of the RF band signals that excludes at least a remainder portion of the RF band signals within the same band group) S1510. Here, the optimized set values may refer to the resistance values of the elements within the down-conversion mixer that minimize intermodulation distortion IMD caused by some RF band signals (e.g., a limited portion of the RF band signals). Specifically, the RF circuit may measure optimized set values for some RF band signals belonging to the same band group input to the RF circuit (e.g., a plurality of first measurement values of the plurality of first RF signals). The RF circuit may measure optimized set values for some RF band signals among the plurality of RF band signals passing through the same band path in the RF circuit. RF circuits may measure optimized set values that reduce or minimize intermodulation distortion components caused by RF band signals. RF circuits may measure optimized set values that reduce or minimize intermodulation distortion components by controlling the resistance values of elements within a down-conversion mixer through which some RF band signals pass.

In some example embodiments, the RF circuit may transmit optimized set values for some RF band signals to the learning model S1520. Here, one or more optimized set values may be expressed as a digital code value, but example embodiments are not limited thereto.

In some example embodiments, the learning model may predict optimized set values for all RF band signals belonging to the same band group as some RF band signals, including both the limited portion of RF band signals, and the remainder portion of RF band signals that are excluded from the limited portion of RF band signals (e.g., a plurality of second measurement values of the RF signals), based on optimized set values for some RF band signals S1530. Based on the optimized set values for some RF band signals, the learning model may predict the optimized set values for all RF band signals passing through the same band path as the limited portion of RF band signals. In some example embodiments, the learning model may predict optimized set values for all RF band signals belonging to the same band group as some RF band signals based on optimized set values for some RF band signals, and output the predicted set values as output data.

In some example embodiments, the learning model may deliver predicted set values for all RF band signals belonging to the same band group as some RF band signals to the RF circuit S1540.

In some example embodiments, the RF circuit may adjust the set values based on predicted set values for all RF band signals S1550. The RF circuit may adjust the resistance values of the elements within the down-conversion mixer according to the predicted set values received from the learning model so as to reduce or minimize intermodulation distortion components.

In some example embodiments, the RF circuit may perform RF calibration of one or more RF band signals (e.g., one or more RF band signals received at the RF circuit from an external device by, or through, an antenna module), to generate calibrated RF band signals using the adjusted set values S1560. In some example embodiments, the RF circuit may implement wireless communication of the RF-calibrated RF band signals, including transmitting the calibrated RF band signals to one or more external devices and/or providing one or more calibrated RF band signals received from one or more external devices S1570, and thus may implement wireless communication with reduced consumption of time, computing resources, and/or electrical power based on implementing such wireless communication at S1570 using RF band signals calibrated at S1560 according to the operations at S1510-S1550. The providing of one or more calibrated RF band signals received from one or more external devices may include transmitting such calibrated RF band signals to one or more other external devices, providing information based on the RF band signals via an audio module (e.g., as emitted sound in example embodiments where the audio model includes an audio speaker) and/or user interface of an electronic device implementing the method of FIG. 15 (e.g., audio module 1413), or any combination thereof.

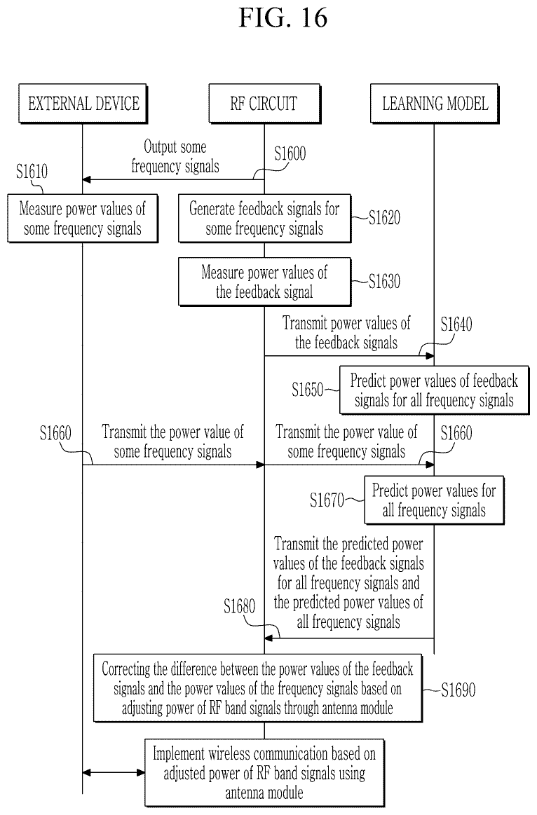

FIG. 16 is a flowchart illustrating a method of operating a computing system according to some example embodiments. The method shown in FIG. 16 may be implemented using an RF circuit which may be any of the RF circuits, modules including same, and/or electronic devices including same shown in any of FIGS. 1 to 14. The method shown in FIG. 16 may be implemented using a learning model which may be any of the learning models including in any of the circuits, devices, modules, or the like shown in any of FIGS. 1 to 14.

In some example embodiments, the RF circuit and the learning model may be included in the same electronic device. However, the RF circuit and the learning model may be included in different electronic devices.

In some example embodiments, the RF circuit may output some frequency signal to an external device S1600. Specifically, the RF circuit may output some of the frequency signals among a plurality of frequency signals within the same frequency band (e.g., a limited portion of the frequency signals) to an external device, where the “some” frequency signals may be a limited portion of the plurality of frequency signals and exclude remainder frequency signals of the plurality of frequency signals.

In some example embodiments, the external device may measure the power value of the some frequency signals S1610.

In some example embodiments, the RF circuit may generate a feedback signal for the limited portion of frequency signals S1620. Specifically, the RF circuit may generate a feedback signal as a replica signal of the limited portion of frequency signals output to an external device.

In some example embodiments, the RF circuit may measure the power value of a feedback signal for the limited portion of frequency signals S1630. RF circuits may convert the feedback signal into power, or measure the power value of the feedback signal using a power detector or the like.

In some example embodiments, the RF circuit may transmit power values of feedback signals for the limited portion of frequency signals to the learning model S1640.

In some example embodiments, the learning model may predict the power values of the feedback signals for all frequency signals (including the “some” frequency signals and the remainder frequency signals) based on the power values of the feedback signals for some frequency signals S1650. In some example embodiments, the learning model learns the tendency of the power values of the feedback signal, and may predict the power values of the feedback signal for all frequency signals based on the power values of the feedback signal for the limited portion of frequency signals.

In some example embodiments, the external device may transmit power values of some measured frequency signals to the learning model S1660. The external device may transmit the power value of the limited portion of frequency signals measured by the external device to the learning model through the RF circuit or directly.

In some example embodiments, the learning model may predict the power values of all frequency signals based on the power values of some frequency signals S1670. In some example embodiments, the learning model learns tendencies in power values of frequency signals, and may predict power values of all frequency signals based on power values of some frequency signals.

In some example embodiments, the learning model may transmit predicted power values of feedback signals for all frequency signals and predicted power values of all frequency signals to the RF circuit S1680.

In some example embodiments, the RF circuit may correct the difference between the predicted power values of the feedback signals for all frequency signals and the predicted power values of all frequency signals, for example based on adjusting the power of RF signals output (e.g., transmitted) from the RF circuit S1690. The RF circuit may calculate the difference between the predicted power values of the feedback signals for all frequency signals and the predicted power values of all frequency signals, and adjust (e.g., increase or decrease) the power of the RF signal output (e.g., transmitted) from the RF circuit to generate adjusted-power RF signals.

In some example embodiments, the RF circuit may implement wireless communication of the adjusted-power RF band signals from the RF circuit, for example using an antenna module, including transmitting adjusted-power RF signals to one or more external devices by or through an antenna module S1692, and thus may implement wireless communication with reduced consumption of time, computing resources, and/or electrical power based on implementing such wireless communication at S1692 using an adjusted power of RF band signals radiated by (through) the antenna module according to the operations at S1610-S1690.

In some example embodiments, an electronic device (e.g., electronic device 10, electronic device 1410, or any combination thereof) may include a processor (e.g., processor 11, which may implement processor 31, 61, or any combination thereof), a memory (e.g., memory 13, which may implement memory 33, memory 62, or any combination thereof), and an RF circuit (e.g., RF circuit 100, which may implement RF circuit 200, 300, 600, or any combination thereof). The RF circuit may include an RFFE (e.g., RFFE 130) electrically connected to an antenna module (e.g., antenna module 140), an RFIC (e.g., RFIC 120) electrically connected to the RFFE, a CP (e.g., CP 110), and a coupler (e.g., coupler 137), although example embodiments are not limited thereto. The memory may store a program of instructions, and the processor may be configured to execute the program of instructions to control the RF circuit to perform RF calibration with regard to RF signals (e.g., RF band signals) among a plurality of frequencies and/or to perform wireless communication operations using such calibrated RF signals. To this end, the processor may execute the program of instructions to (1) determine a plurality of first RF (radio frequency) signals among RF signals of a plurality of frequencies (e.g., a limited portion of the RF signals that excludes at least a remainder portion of the RF signals), (2) obtain a plurality of first measurement values of the plurality of first RF signals, and (3) determine a predicted plurality of second measurement values of the RF signals using a learning model, based on the plurality of first measurement values.

The processor may execute the program of instructions to determine the predicted plurality of second measurement values based on implementing a learning model stored in the memory. The processor may execute the program of instructions to determine the predicted plurality of second measurement values based on transmitting the plurality of first measurement values to a separate electronic device that implements the learning model to determine the predicted plurality of second measurement values, and subsequently receiving the predicted plurality of second measurement values from the separate electronic device.

The processor may be configured to execute the program of instructions to perform RF calibration using the predicted plurality of second measurement values, for example based on applying the predicted plurality of second measurement values to adjust one or more set values, setting values, or the like of one or more components of the RF circuit (e.g., adjusting set values that are resistance values of elements in a down-conversion mixer of the RF circuit, adjusting a power of RF signals transmitted through an antenna module of the RF circuit, any combination thereof, or the like).

The processor may be configured to execute the program of instructions to perform RF calibration based on controlling the RF circuit to perform RF calibration on the RF signals based on the predicted second measurement values, including for example set values such as resistance values of elements in a down-conversion mixer of the RF circuit that may be adjusted based on the predicted second measurement values, so as to generate calibrated RF signals, also referred to herein as RF-calibrated RF signals.

The processor may be configured to execute the program of instructions to perform RF calibration based on adjusting a power of RF signals transmitted through an antenna module of the RF circuit based on the predicted second measurement values (e.g., based on a difference between a power value of a feedback signal and a power value of a frequency signal).

The processor may be configured to execute the program of instructions to perform one or more wireless communication operations supporting wireless communication between the electronic device and one or more external devices based on the RF calibration. Such performing of wireless communication may include controlling the RF circuit to transmit the calibrated RF signals (calibrated based on performing the RF calibration on the RF signals) to one or more external devices, to transmit RF signals using the adjusted power of the RF signals to one or more external devices, any combination thereof, or the like. Such performing of wireless communication may include controlling the RF circuit to perform RF calibration on RF signals received from an external device and providing the so-calibrated RF signals via an interface of the electronic device (e.g., as sound emitted via an audio module) and/or to one or more external devices based on transmission of the calibrated RF signals though an antenna module of the RF circuit.

The RF circuit may be configured to process RF signals where each RF signal of the RF signals is a center frequency of each frequency band of a plurality of frequency bands, the plurality of frequency bands comprising the plurality of frequencies, and the RF circuit is configured to cause the RF signals to pass through a path in the RF circuit.

The processor may be configured to execute the program of instructions to obtain the plurality of first measurement values of the plurality of first RF signals based on controlling the RF circuit to input the plurality of first RF signals (e.g., RF signals received at the RF circuit from an external device via an antenna module, RF signals received at the RF circuit from an audio module converting sound to RF signals, etc.) to a down-conversion mixer of the RF circuit, adjust set values for controlling intermodulation distortion generated in the down-conversion mixer, and obtain, as the plurality of first measurement values, adjusted set values that minimize the intermodulation distortion.

The processor may be configured to execute the program of instructions to determine the predicted plurality of second measurement values of the RF signals using the learning model, based on the plurality of first measurement values, further based on inputting the plurality of first measurement values to the learning model (e.g., based on executing a learning model stored in the memory), determining predicted set values that minimize the intermodulation distortion for the RF signals using the learning model, and outputting the predicted set values as the predicted plurality of second measurement values. The set values may be resistance values of elements in the down-conversion mixer.

The RF signals may be signals in a frequency band. The processor may be configured to execute the program of instructions to obtain the plurality of first measurement values of the plurality of first RF signals based on controlling the RF circuit to generate a plurality of first feedback signals of the plurality of first RF signals radiated toward an external device through an antenna module, and measure respective power values of the plurality of first feedback signals. The processor may be configured to execute the program of instructions to determine the predicted plurality of second measurement values of the RF signals using the learning model, based on the plurality of first measurement values, further based on inputting the plurality of first measurement values to the learning model, determining predicted power values of a plurality of second feedback signals of the RF signals radiated through an antenna module using the learning model, and outputting the predicted power values of the plurality of second feedback signals as the predicted plurality of second measurement values.

The processor may be configured to execute the program of instructions to input received power values of the plurality of first RF signals received from an external device to the learning model, determine predicted power values of the RF signals radiated through the antenna module using the learning model, based on the power values of the plurality of first RF signals, and output (e.g., transmit) the predicted power values of the RF signals.

The processor may be configured to execute the program of instructions to control the RF circuit to perform the RF calibration using the predicted plurality of second measurement values based on receiving the predicted plurality of second measurement values and the predicted power values of the RF signals, calculating a difference value between the predicted plurality of second measurement values and the predicted power values of the RF signals, and adjusting power of the RF signals radiated through the antenna module based on the difference value.

The learning model may be a CNN (Convolutional Neural Network) model.

In some example embodiments, an operating method of a computing system that includes first and second electronic devices (e.g., computing system 1400 including at least electronic devices 1410 and 1440 as shown in FIG. 14) may include (1) generating, at a first electronic device, a plurality of first RF (radio frequency) signals among RF signals of a plurality of frequency bands, (2) measuring, at the first electronic device, a plurality of first set values of a down-conversion mixer of the first electronic device (e.g., of an RF circuit of the first electronic device) that configure the down-conversion mixer to optimize characteristics of the plurality of first RF signals, and (e.g., at S1510), (3) outputting (e.g., transmitting), from the first electronic device to the second electronic device, the plurality of first set values (e.g., at S1520). The operating method may further include (4) receiving, at the second electronic device, the plurality of first set values, and (5) determining, at the second electronic device, a predicted plurality of second set values that are determined to configure the down-conversion mixer to optimize one or more characteristics of the RF signals using a learning model (e.g., at S1530).

The operating method may further include transmitting the predicted plurality of second set values from the second electronic device to the first electronic device (e.g., at S1540).

The operating method may further include performing RF calibration at the first electronic device based on the predicted plurality of second set values (e.g., at S1550). The RF calibration may include controlling an RF circuit of the first electronic device to perform RF calibration on the RF signals based on the predicted second measurement values, including for example set values such as resistance values of elements in a down-conversion mixer of the RF circuit that may be adjusted based on the predicted plurality of second set values, so as to generate calibrated RF signals, also referred to herein as RF-calibrated RF signals. The RF calibration may include adjusting a power of RF signals transmitted through an antenna module of an RF circuit of the first electronic device based on the predicted plurality of second set values (e.g., based on a difference between a power value of a feedback signal and a power value of a frequency signal).

The plurality of first set values of the down-conversion mixer of the RF circuit of the first electronic device may configure the down-conversion mixer to optimize the characteristics of the plurality of first RF signals may be resistance values of elements in the down-conversion mixer, and the resistance values may configure the down-conversion mixer to minimize intermodulation distortion generated in the down-conversion mixer by the plurality of first RF signals. The operating method may include performing the RF calibration based on adjusting resistance values of elements in the down-conversion mixer based on the plurality of second set values.

The operating method may further include performing one or more wireless communication operations at the first electronic device to support wireless communication between the first electronic device and one or more external devices based on the RF calibration (e.g., at S1570). Such performing of wireless communication may include controlling a RF circuit at the first electronic device to transmit the calibrated RF signals (calibrated based on performing the RF calibration on the RF signals) to one or more external devices, to transmit RF signals using the adjusted power of the RF signals to one or more external devices, any combination thereof, or the like. Such performing of wireless communication may include controlling the RF circuit to perform RF calibration on RF signals received from an external device and providing the so-calibrated RF signals via an interface of the electronic device (e.g., as sound emitted via an audio module) and/or to one or more external devices based on transmission of the calibrated RF signals though an antenna module of the RF circuit.

In some example embodiments, an operating method of a computing system that includes first and second electronic devices (e.g., computing system 1400 including at least electronic devices 1410 and 1440 as shown in FIG. 14) may include (1) outputting (transmitting), at the first electronic device, a plurality of first RF (radio frequency) signals among RF signals of a plurality of frequencies to an external device through an antenna module (e.g., at S1600), (2) generating, at the first electronic device, a plurality of first feedback signals of the plurality of first RF signals (e.g., at S1620), and, (3) measuring, at the first electronic device, power values of the plurality of first feedback signals (e.g., at S1630). The operating method may include transmitting, from the first electronic device to the second electronic device, the power values of the first feedback signals (e.g., at S1640). The operating method may further include (4) receiving, at the second electronic device, the power values of the plurality of first feedback signals from the first electronic device, and (5) determining, at the second electronic device, predicted power values of a plurality of second feedback signals of the RF signals using a first learning model based on the power values of the plurality of first feedback signals (e.g., at S1650).

The operating method may include transmitting, from the first electronic device to the second electronic device, the power values of the plurality of first RF signals from the external device (e.g., at S1660), and determining, at the second electronic device, predicted power values of the RF signals using a second learning model based on the power values of the plurality of first RF signals (e.g., at S1670).

The operating method may include determining, at the second electronic device, predicted power values of the RF signals using a second learning model based on the power values of the plurality of first feedback signals.

The operating method may include transmitting the predicted power values of a plurality of second feedback signals of the RF signals and the predicted power values of the RF signals from the second electronic device to the first electronic device (e.g., at S1680).

The operating method may further include correcting, at the first electronic device, a difference between the power value of the feedback signals, and the power values of the frequency signals (e.g., at S1690). The operating method may further include adjusting the power of RF band signals transmitted through an antenna module of the first electronic device based on the correcting of the difference.

The operating method may further include performing one or more wireless communication operations at the first electronic device to support wireless communication between the first electronic device and one or more external devices based on the RF calibration (e.g., at S1692). Such performing of wireless communication may include controlling a RF circuit at the first electronic device to transmit RF signals using the adjusted power of the RF signals to one or more external devices.

As described herein, any devices, systems, modules, portions, units, controllers, circuits, and/or portions thereof according to any of the example embodiments, and/or any portions thereof (including, without limitation, electronic device 10, processor 11, memory 13, learning model 15, RF circuit 100, CP 110, RFIC 120, transmitter 121, receiver 123, feedback circuit 125, RFFE 130, PA 131, LNA 133, switch 135, coupler 137, antenna module 140, RF circuit 200, CP 210, RFIC 220, down-conversion mixer 221_1, filter 221_3, first band path 221, second band path 223, third band path 225, antenna switch module 231, BPF 232, BP2 232_1, LNA 233, LNA 233_1, antenna module 240, RF circuit 300, transmitter 321, signal generator 322, transmit circuit 324, receiver 325, down-conversion mixer 326, calibration logic 327, processor 31, memory 33, learning model 35, learning model 510, RF circuit 600, CP 610, calibration logic 611, RFIC 620, feedback circuit 621, RFFE 630, antenna module 640, coupler 650, processor 61, memory 63, learning model 1 65_1, learning model 2 65_2, external device 900, first learning model 810, electronic device 60, second learning model 1110, learning model 1310, computing system 1400, electronic device 1410, processor 1411, memory 1412, audio module 1413, antenna module 1414, communication module 1415, connector 1416, network 1420, electronic device 1430, electronic device 1440, learning model 1441, electronic device 1450, measuring device 1451, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

In some example embodiments, the learning models according to any of the example embodiments, including any of the learning models illustrated and described with regard to any of FIGS. 1 to 14, may be understood to be implemented by one or more articles (e.g., units) of processing circuitry, for example based on a processor (e.g., processor 11, processor 31, processor 61, processor 1411, a processor of electronic device 1440, etc.) executing a program of instructions stored in a memory (e.g., memory 13, memory 33, memory 63, memory 1412, a memory of electronic device 1440, etc.). As an example, a learning model as described herein may be implemented based on processing circuitry (e.g., a processor executing a program of instructions stored in a memory) implementing a large language model that is trained on a set of training data by, for example, a supervised, unsupervised, and/or reinforcement learning model, and wherein the processing circuitry may process a feature vector to provide output of a learning model according to any of the example embodiments based upon the training. Such large language model that may be implemented by processing circuitry to implement a learning model according to any of the example embodiments may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively, or additionally, the processing circuitry may implement a learning model according to some example embodiments based on including other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, a large model that may be implemented by processing circuitry to implement a learning model according to some example embodiments may have any structure that is trainable, e.g., with training data. For example, the large language model may include an artificial neural network, a decision tree, a support vector machine, a Bayesian network, a genetic algorithm, and/or the like. Non-limiting examples of the large language model may include a convolution neural network (CNN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

Herein, a learning model that may be implemented by processing circuitry according to some example embodiments may, for example, have a structure that is trainable, e.g., with training data, such as an artificial neural network, a decision tree, a support vector machine, a Bayesian network, a genetic algorithm, and/or the like. Non-limiting examples of the trainable structure may include a convolution neural network (CNN), a generative adversarial network (GAN), an artificial neural network (ANN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like. In at least one example embodiment, the learning model may be a Large Language Model (LLM). The Large Language Model is an AI system configured to understand and generate human language by processing large amounts of unlabeled linguistic (e.g., textual, audio, and/or the like) data based on a deep learning method.

Although some example embodiments of the present inventive concepts have been described in detail above, the scope of the present inventive concepts is not limited thereto, and various modifications and improvements made by those skilled in the art using the basic concepts of the present inventive concepts defined in the following claims also fall within the scope of the present inventive concepts.

What is claimed is:

1. An operating method of an electronic device, the operating method comprising:
determining a plurality of first RF (radio frequency) signals among RF signals of a plurality of frequencies,
obtaining a plurality of first measurement values of the plurality of first RF signals,
determining a predicted plurality of second measurement values of the RF signals using a learning model, based on the plurality of first measurement values, and
performing RF calibration using the predicted plurality of second measurement values.

2. The operating method of claim 1, wherein:
each RF signal of the RF signals is a center frequency of each frequency band of a plurality of frequency bands, the plurality of frequency bands comprising the plurality of frequencies, and
the RF signals pass through a path in an RF circuit within the electronic device.

3. The operating method of claim 2, wherein the obtaining the plurality of first measurement values of the plurality of first RF signals comprises:
inputting the plurality of first RF signals to a down-conversion mixer,
adjusting set values for controlling intermodulation distortion generated in the down-conversion mixer, and
obtaining, as the plurality of first measurement values, adjusted set values that minimize the intermodulation distortion.

4. The operating method of claim 3, wherein the determining the predicted plurality of second measurement values of the RF signals using the learning model, based on the plurality of first measurement values, comprises:
inputting the plurality of first measurement values to the learning model,
determining predicted set values that minimize the intermodulation distortion for the RF signals using the learning model, and
outputting the predicted set values as the predicted plurality of second measurement values.

5. The operating method of claim 4, wherein:
the set values are resistance values of elements in the down-conversion mixer.

6. The operating method of claim 1, wherein:
the RF signals are signals in a frequency band.

7. The operating method of claim 6, wherein the obtaining the plurality of first measurement values of the plurality of first RF signals comprises:
generating a plurality of first feedback signals of the plurality of first RF signals radiated toward an external device through an antenna module, and
measuring respective power values of the plurality of first feedback signals.

8. The operating method of claim 6, wherein the determining the predicted plurality of second measurement values of the RF signals using the learning model, based on the plurality of first measurement values comprises:
inputting the plurality of first measurement values to the learning model,
determining predicted power values of a plurality of second feedback signals of the RF signals radiated through an antenna module using the learning model, and
outputting the predicted power values of the plurality of second feedback signals as the predicted plurality of second measurement values.

9. The operating method of claim 7, further comprising:
receiving power values of the plurality of first RF signals from the external device,
inputting the power values of the plurality of first RF signals to the learning model,
determining predicted power values of the RF signals radiated through the antenna module using the learning model, based on the power values of the plurality of first RF signals, and
outputting the predicted power values of the RF signals.

10. The operating method of claim 9, wherein the performing the RF calibration using the predicted plurality of second measurement values comprises:
receiving the predicted plurality of second measurement values and the predicted power values of the RF signals,
calculating a difference value between the predicted plurality of second measurement values and the predicted power values of the RF signals, and
adjusting power of the RF signals radiated through the antenna module based on the difference value.

11. The operating method of claim 1, wherein:
the learning model is a CNN (Convolutional Neural Network) model.

12. A computing system, comprising:
a first electronic device configured to
generate a plurality of first RF (radio frequency) signals among RF signals of a plurality of frequency bands,
measure a plurality of first set values of a down-conversion mixer that configure the down-conversion mixer to optimize characteristics of the plurality of first RF signals, and
output the plurality of first set values; and
a second electronic device configured to
receive the plurality of first set values, and
determine a predicted plurality of second set values that are determined to configure the down-conversion mixer to optimize one or more characteristics of the RF signals using a learning model.

13. The computing system of claim 12, wherein:
the RF signals pass through a path in an RF circuit within the first electronic device.

14. The computing system of claim 12, wherein:
the plurality of first set values of the down-conversion mixer that configure the down-conversion mixer to optimize the characteristics of the plurality of first RF signals are resistance values of elements in the down-conversion mixer, and the resistance values configure the down-conversion mixer to minimize intermodulation distortion generated in the down-conversion mixer by the plurality of first RF signals.

15. The computing system of claim 12, wherein:
the first electronic device is configured to receive the plurality of second set values, and adjust resistance values of elements in the down-conversion mixer based on the plurality of second set values.

16. A computing system, comprising:
a first electronic device configured to
output a plurality of first RF (radio frequency) signals among RF signals of a plurality of frequencies to an external device through an antenna module,
generate a plurality of first feedback signals of the plurality of first RF signals, and
measure power values of the plurality of first feedback signals; and
a second electronic device configured to
receive the power values of the plurality of first feedback signals from the first electronic device, and
determine predicted power values of a plurality of second feedback signals of the RF signals using a first learning model based on the power values of the plurality of first feedback signals.

17. The computing system of claim 16, wherein:
the RF signals are signals in a first frequency band.

18. The computing system of claim 16, wherein:
the second electronic device is configured to receive power values of the plurality of first RF signals from the external device, and determine predicted power values of the RF signals using a second learning model based on the power values of the plurality of first RF signals.

19. The computing system of claim 18, wherein:
the first electronic device is configured to receive the predicted power values of the plurality of second feedback signals and the predicted power values of the RF signals, and adjust power values of the RF signals output from the antenna module based on a difference between the predicted power values of the plurality of second feedback signals and the predicted power values of the RF signals.

20. The computing system of claim 16, wherein:
the second electronic device is configured to determine predicted power values of the RF signals using a second learning model based on the power values of the plurality of first feedback signals.
